(19) United States
(12) Patent Application Publication
(10) Pub. No.: US 2017/0020764 A1
(43) Pub. Date: Jan. 26, 2017

(54) Walker standing aid accessory

(71) Applicants: Gary Dempsey Morris, Paris, TN (US); Nancy Elaine Moore-Morris, Paris, TN (US)

(72) Inventors: Gary Dempsey Morris, Paris, TN (US); Nancy Elaine Moore-Morris, Paris, TN (US)

(21) Appl. No.: 14/756,038

(22) Filed: Jul. 24, 2015

(51) Int. Cl. A61H 3/00

(52) U.S. Cl. CPC A61H 3/00

(57) ABSTRACT

A walker standing aid accessory package consists of a lower attachment and an upper attachment. The lower foot bar piece allows the caregiver to utilize body weight to pin the walker's front legs to the floor or ground surface securely. The upper part incorporates multiple hand placement stabilization choices for both the patient and the caregiver. This invention increases patient's self help and reduces most of the caregiver's exertion. Once the patient is standing upright, the caregiver may step aside and monitor said patients immediate ambulation. The accessory package converts an existing walker into a device that not only helps the patient to stand but also reduces the strain on the caregiver. The walker with the accessories installed offers no interference or compromise to the existing walker's integrity, mobility or storage.

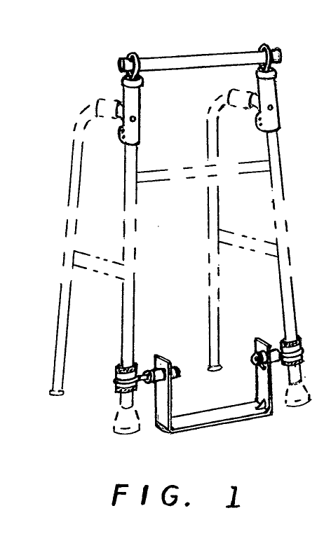

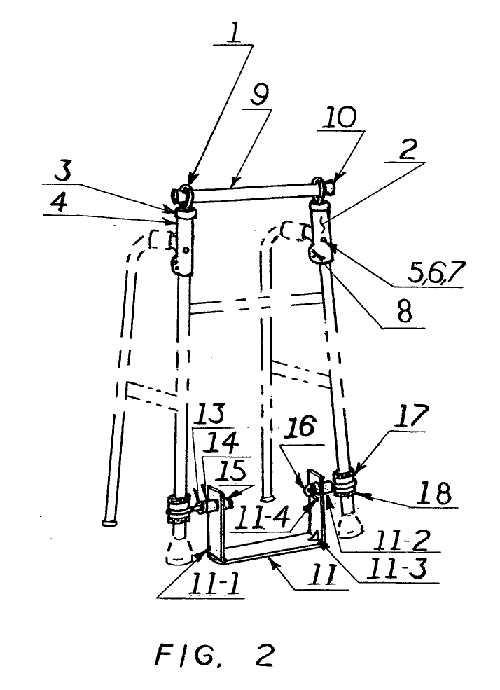

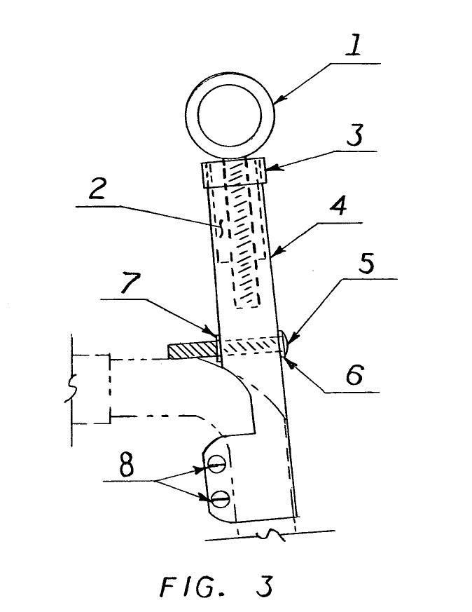

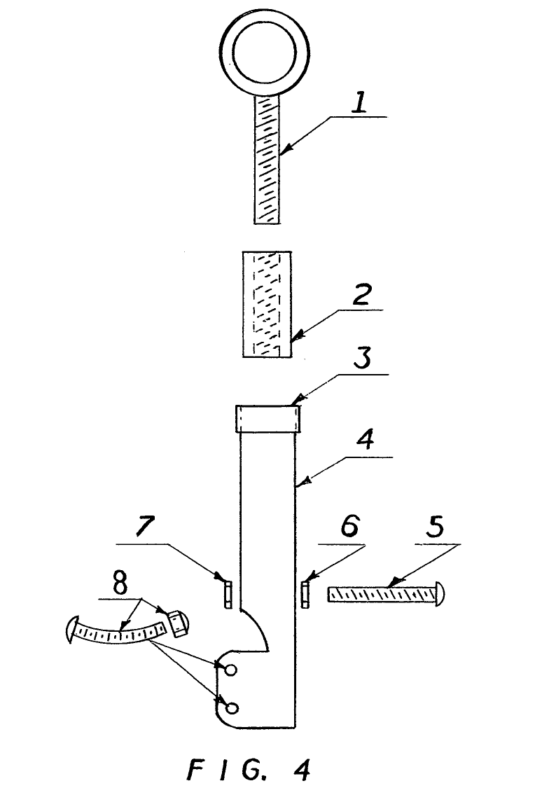

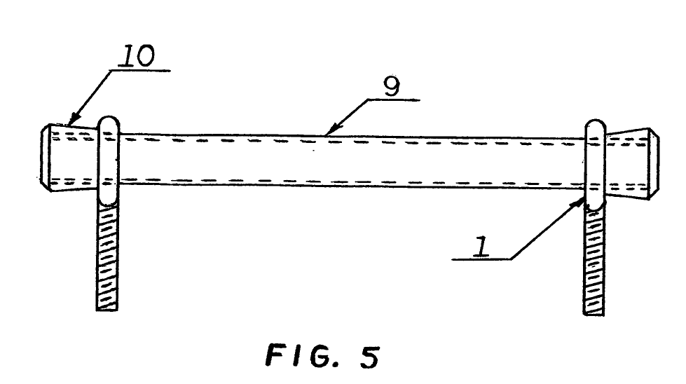

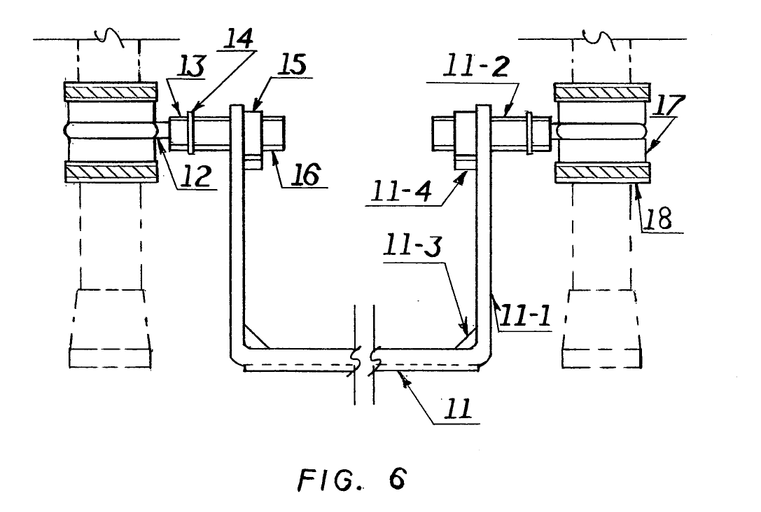

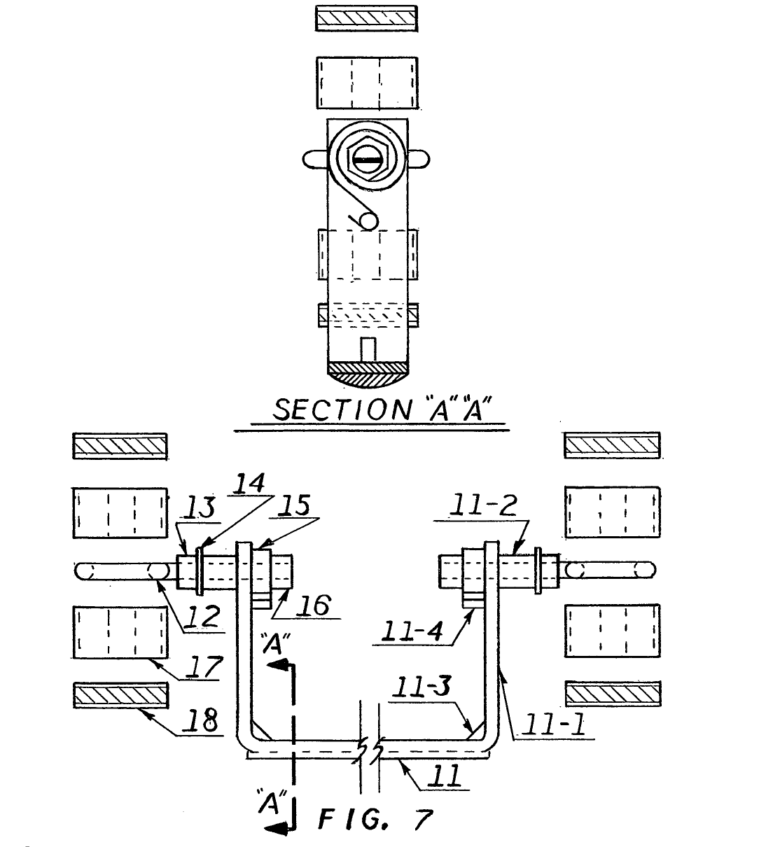

### BACKGROUND OF INVENTION

The present invention relates to a mobility aid accessory package which is applied to an already existent walker ambulation device framework.

It has been determined by study of prior art that many attempts have successfully accomplished the task of assistance to a person trying to move from a seated to a standing position.

It has been further determined through investigation and observation that once standing upright the individual is often unable to make transfer from one device to another, due to tripping hazards or patient instability.

The present invention overcomes this obstacle through an accessorizing method by applying specifically designed aid devices to the patients already existent walker appliance. This invention also aids the caregiver in that they can use their body weight and minimal physical exertion to assist patient. Once standing the patient is then able to begin ambulation immediately. This invention also works in reverse when the patient needs to be seated.

The accessorizing method adds little weight to a walker and the walker may still be folded closed and immediately transported with the person or patient to the next needed location.

### SUMMARY OF INVENTION

Many types and configurations of personal assisting devices are known. Most devices are able to assist patients with rising from a seated to standing position. However, in most cases the devices are stand alone and do not allow the patient or person ambulation. There then becomes a need in those cases for transference to some other conveyance.

The accessories herein described not only overcome much of the difficulty that a person experiences when trying to stand, but also aid the caregiver in helping the patient/person to a standing position using their own weight applied to the foot bar, as a counter balance along with hand stabilization applied to the top piece. The caregiver exerts little physical effort during this maneuver. The same walker that was utilized for assistance, is then already in position for person or patient's immediate ambulation.

The accessory (Lower and Upper Units) work together for the combined purpose of assistance in rising, as well as sitting back down. The accessories do not interfere with patient/person motion and are away from any path that would result in a tripping hazard during ambulation.

Incorporation of the foot bar works to counteract tipping motion of the walker and the hand grip locations at the top of the walker allow choices for both the patient/person or the caregiver for needed hand placement.

Once the patient/person is upright and stable the caregiver moves away and the walker is allowed to function and provide support as per it's originally intended design.

The accessory package does not compromise any of an existing walker's integrity and requires no walker modification. All accessories are clamped to or slip mounted to the existing walker framework. With accessories installed the walker experiences a very small amount of added weight and still may be folded closed or opened as per original design.

### BRIEF DESCRIPTIONS OF THE DRAWINGS

FIG. (1) SHEET (1 OF 7) Perspective drawing of upper and lower accessory package installed on an existing walker (walker in phantom) with numbers removed.

FIG. (2) SHEET (2 OF 7) Perspective drawing of upper and lower accessory package installed on an existing walker (walker in phantom) with numbers assigned.

FIG. (3) SHEET (3 OF 7) View of upright piece installed on walker framework. Two pieces required. (walker in phantom)

FIG. (4) SHEET (4 OF 7) Exploded view of upright piece. Two pieces required.

FIG. (5) SHEET (5 OF 7) View of round tubular crossbar piece positioned in eyelet bolts of upright pieces.

FIG. (6) SHEET (6 OF 7) View of foot bar piece installed on lower front legs of an existing walker. (walker in phantom)

FIG. (7) SHEET (7 OF 7) Exploded view and sectional view of foot bar piece.

PLEASE REFER TO DRAWINGS THAT FOLLOW.

### DETAILED DESCRIPTION OF THE INVENTION

Prior art offers many aids and solutions to lessen the hardship handicapped persons suffer while trying to stand, sit or ambulate. The hardship is extended to the caregiver when additional assistance is required.

The present invention is an accessory package designed to be installed on and increase the capability of an existent walker appliance. Prior art has revealed many stand alone appliances. Accessorizing as is herein described has not been identified in prior art.

The installed walker standing aid accessory package affords the caregiver the ability to assist someone to stand or sit with little caregiver exertion. This is accomplished by the accessory foot bar piece and the accessory upright pieces.

The caregiver applies pressure with one foot to the foot bar. The foot bar has incorporated thereto a rotation action. Said rotation allows the base of the foot bar to rotate forward toward the caregiver and makes contact with the floor or ground surface. This locks the walkers front legs to the floor and prevents forward, backward or lateral motion. Additionally the caregiver utilizes the top part installed accessories to further stabilize the walker, by grasping the top crossbar or the upright supports.

Once the caregiver stabilizes the walker, the patient may grasp by their choice the existing walker framework, the upright pieces, the top crossbar or using any combination thereof.

As the patient pulls their self upward the caregiver acts as an counter opposing force.

The same method may be utilized by reversal to allow patient to seat their self.

Once the patient is in the standing position, the caregiver releases the grasping of the top accessory area, along with removing their foot from the foot bar.

The foot bar automatically rotates back up to its original position away from the floor surface. The walker is now ready to allow the patient immediate ambulation.

There is no need for transfer to any other appliance and tripping hazards are eliminated due to the location of the accessory placement.

The following elemental descriptions explain in detail each component numerically identified in the previous drawing illustrations.

THREADED EYE BOLT (1) Provides support for both ends (Left and Right) of crossbar piece. The threaded portion of the eye bolt is screwed down into threaded insert (2). The threaded length provides allowance for height adjustment and swivel rotation. Said rotation accommodates the opening and closing of the walker while maintaining appliance attachment.

THREADED INSERT (2) is fitted permanently in the top portion of the left and right upright pieces (4). The insert provides the mounting location for the threaded eye bolt (1).

PROTECTIVE CAPS (3) are incorporated to provide safety and hand comfort for the user or caregiver and secures cross bar (9) in place.

UPRIGHT PIECE (4) provides vertical hand grip support along with a mounting location for the crossbar piece. Upright pieces are bolt or clamp attached to the left and right upper frontal area of an existing walker. The composition may be metallic or composite. The lower portion of the upright piece is contour fabricated to allow full surface contact with the walker framework. The upright piece is also predrilled clear through to receive a bracing bolt (5) which further supports uprights (4).

BRACING SUPPORT BOLT(5) (6) (7) (3 parts) Brace Support Bolt (5), Brace Support Bolt Adjusting nut (6), and Brace Support Bolt Lock Nut (7). The bracing bolt (5) extends through the drilled hole at the lower portion of the upright piece (4) and is adjusted to make contact with the upper tubular portion of the walker framework, left and right sides. The bracing bolt (5) is then locked in place and helps counter act any pulling force applied to the upright or crossbar pieces.

See part (6) in [0033] description above.

See part (7) in [0033] description above.

UPRIGHT PIECE CLAMPING BOLTS (8) affix the upright pieces (4) to the left and right side of the frontal upper portion of the existing walker. The upright pieces (4) are slipped onto the upper portion of the existing walker left and right sides. Once in place the clamping bolts (8) hold upright pieces securely to walker frame work. In lieu of bolts (8), the upright piece may be bolted to the walker at the same location but permission must be given for any breeching or drilling of existing walker framework.

CROSSBAR PIECE (9) is round/tubular in construction and is fabricated from either metallic or composite materials.The crossbar piece provides connection between upright pieces (4) left and right. The crossbar passes through the eyelet portion of the eyelet bolts (1) and is locked in place by crossbar piece protective locking caps (10). The crossbar piece provides the assisted person or the caregiver a horizontal hand placement location. The pulling motion on either the horizontal crossbar piece (9) or the vertical upright piece (4) is counter acted by the opposing force of the care givers hand placement along with the locking to the floor surface provided by the caregiver. Said floor locking will be explained hereafter.

See part (10) in [0037] description above.

FOOT BAR PIECE (11) is attached to the lower frontal legs area of an existing walker. Said foot bar piece (11) is fabricated of either metallic or composite materials or combination thereof.

The foot bar piece (11) and cross bar piece (9) are used in conjunction by the caregiver. The caregiver places his or her foot on the foot bar piece when assisting a seated person to stand. The body weight of the caregiver pins the front legs of the walker to the floor or ground surface via the foot bar piece.This pinning arrangement provides a counteracting force when the patient/person utilizes the top portion to pull against while trying to rise from a seated position. This greatly decreases the strength normally required from the caregiver to assist the patient. When not in use the Foot bar piece (11) rotates back upward.

Once the patient or person is upright and safely standing the caregiver steps away from the front of the walker and the person then utilizes the walker as originally intended for ambulation.

With reference to the foot bar piece proper (11); the lowest part of foot bar piece (11) is fabricated flat on the top side and curved on the floor surface contact side. This configuration allows the foot bar piece (11) to smoothly release contact with the floor surface when caregiver foot pressure is removed. The drop down suspensions (11-1) both left and right side allow adequate height to connect foot bar piece to walker leg framework (at an elevated location that does not interfere with walker wheels, glides etc.). The elongated nuts (11-2) are permanently affixed to drop downs (11-1) at the top locations. Said nuts allow drop downs (11-1) to receive threaded eyelet bolts (12). The combination of threaded nuts and threaded eyelet bolts provide the necessary pivoting locations (upward and downward) for foot bar piece (11). The torsion spring mounting post (11-4). Said mounting post is permanently affixed to upper location of drop down suspensions (11-1). Mounting post (11-4) receives the outermost end of torsion springs (15).

With further reference to drop down suspensions (11-1); said drop down suspensions are drilled clear through to allow threaded portions of eyelet bolts (12) to extend through the upper portion of drop downs (11-1).

With further reference to foot bar piece (11); reinforcing gussets (11-3) help reduce flexing action between the foot bar lower part and the drop down suspensions (11-1).

With further reference to foot bar piece (11). Foot bar piece (11) has located at the top portion eyelet bolts (12) both left and right side. Said eyelet bolts allow foot bar piece to be mounted on an existing walker's frontal area near the base. Said eyelet bolts provide a rigid support for foot bar piece proper (11) while simultaneously allowing frontal walker legs to rotate therein approximately ninety degrees. Said rotation accommodates the opening and closing of walker frame work without removal of foot bar piece proper (11). Eyelet bolts (12) are fabricated with a slotted thread arrangement. Said slot provides necessary mounting for the center portion of torsion springs (15). Said torsion springs allow foot bar piece (11) to return to the upright position once caregiver foot pressure has been removed. Once rotated back upright the torsion spring (15) holds foot bar piece (11) upward and away from the path of ambulation.

With further reference to eyelet bolt (12); eyelet bolts (12) provide necessary mounting for stop nuts (13), spacer (14), torsion springs (15), and locking cap nut (16). Stop nuts (13) provide travel limitation both upward and downward for foot bar piece (11). Spacer (14) provides a separation with slippage between stop nuts (13) and elongated nuts (11-2). Torsion spring (15) allows foot bar piece to automatically return to upright position when caregiver's foot is removed from foot bar piece (11). The above described assembly is secured in place by locking cap nuts (16).

With further reference to foot bar piece (11) and eyelet bolts (12); Foot bar piece makes contact with walker leg framework at the bolt eyelet location. Bolt eyelets both left and right side are supported via top and bottom support sleeves (17). Said support sleeves slide onto and tightly grip the existing walker legs both left and right side. The eyelet bolts (12) rest on lower support sleeves both left and right side while the upper support sleeves help provide proper alignment and rigidity. Additionally support sleeves are slotted vertically top to bottom in order to accommodate walker leg adjusting pins. The walker may then be height adjusted with the foot bar assembly (11) installed.

With further reference to top and bottom support sleeves (17); said sleeves are securely held in place by compression clamps (18).

1. A walker comprising:
a first lateral side having a front leg spaced from a rear leg, each of the first lateral side front and rear legs having a distal end configured to contact a support surface on which the walker is used, a first lateral side strut extending transversely between the first lateral side front and rear legs and spaced from the distal ends of the first lateral side front and rear legs;
a second lateral side spaced from the first lateral side, the second lateral side having a front leg spaced from a rear leg, each of the second lateral side front and rear legs having a distal end configured to contact a support surface on which the walker is used, a second lateral side strut extending transversely between the second lateral side front and rear legs and spaced from the distal ends of the second lateral side front and rear legs;
a hand grip extending from the first lateral side front leg adjacent to the first lateral side strut and a hand grip extending from the second lateral side front leg adjacent to the second lateral side strut.
a crossbar extending from the first lateral side adjacent to the first lateral side strut to the second lateral side adjacent to the second lateral side strut; and
a foot bar with opposite first and second ends and a bearing surface extending between the first and second ends, the foot bar first end being operatively pivotally connected to the first lateral side front leg, the foot bar second end being operatively pivotally connected to the second lateral side front leg, the foot bar being pivotal between a retracted position in which the foot bar bearing surface is spaced from the support surface on which the walker is placed, and a deployed position in which the foot bar bearing surface moves parallel and adjacent to the support surface on which the walker is used.

2. The walker of claim 1 wherein the cross bar is operatively pivotally connected to the respective first and second lateral sides thereby allowing the first and second lateral sides to pivot toward and away from each other.

3. The walker of claim 2 wherein the crossbar is operatively pivotally connected to the first and second lateral sides in a manner such that the pivotal connection is orthogonally movable toward and away from the struts of the first and second lateral sides.

4.-8. (canceled)

9. The walker of claim 1 wherein foot bar piece is operatively pivotally connected to the front legs of the first and second lateral sides with a biasing member that urges the foot bar to the retracted position.

10. The walker of claim 1 wherein foot bar first and second ends are pivotally connected to the respective first and second lateral sides to define a pivot axis offset from the foot bar bearing surface.

11. The walker of claim 1 wherein foot bar has reinforcement gussets at the first and second ends of the foot bar.

12. (canceled)

13. The walker of claim 1 wherein the foot bar is operatively pivotally connected to the first and second lateral sides in a manner such that the pivotal connection is pivotal about the front legs of the first and second lateral sides thereby allowing the first and second lateral sides to pivot toward and away from each other.

14. The walker of claim 1 wherein the foot bar is operatively pivotally connected to the first and second lateral sides in a manner such that the pivotal connection is orthogonally movable toward and away from the struts of the first and second lateral sides.

15.-18. (canceled)

19. A walker comprising:
a frame with opposite lateral sides;
a cross bar having opposite first and second ends, the cross bar first and second ends operatively connected to respective opposite lateral sides of the frame; and
a foot bar having first and second ends each operatively pivotally connected to respective opposite lateral sides of the frame about a foot bar pivot axis, the foot bar having a bearing surface extending between the first and second ends, the foot bar being pivotal about the foot bar pivot axis between a retracted position in which the foot bar bearing surface is spaced from a support surface on which the walker is placed, and a deployed position in which the foot bar bearing surface moves parallel and adjacent to the support surface on which the walker is placed.

20. The walker of claim 19, further comprising:
a first hand grip extending outward from the frame adjacent to the first end of the cross bar; and
a second hand grip extending outward from the frame adjacent to the second end of the cross bar.

21. The walker of claim 19 wherein the first end of the foot bar each has a first arm extending perpendicularly to the foot bar and the second end of the foot bar each has a second arm extending perpendicularly to the foot bar.

22. The walker of claim 21 wherein the first and second arms of the foot bar have pivot connections with the respective lateral opposite sides of the frame at the foot bar pivot axis.

23. The walker of claim 19, wherein the first and second ends of the foot bar are operatively pivotally connected to the respective lateral opposite sides of the frame with a biasing member that urges the foot bar to the retracted position.

24. The walker of claim 19 wherein the foot bar is operatively pivotally connected to respective lateral opposite sides of the frame such that the pivotal connection is pivotal about an axis perpendicular to the foot bar pivot axis thereby allowing the lateral opposite sides of the frame to pivot toward and away from each other.

25. The walker of claim 19 wherein the foot bar is operatively pivotally connected to respective lateral opposite sides of the frame such that the pivotal connection is movable along a direction perpendicular to a plane defined by the foot bar bearing surface when the foot bar is in the deployed position.

26. An accessory package for a walker, the accessory package comprising:
a foot bar having first and second ends and a bearing surface extending between the first and second ends; and
first and second pivot connections configured to connect to respective first and second ends of the foot bar and respective laterally opposite sides of a frame of the walker, each of the pivot connections having a foot bar pivot axis about which the foot bar pivots when connected to the frame of the walker between a retracted position in which the foot bar bearing surface is spaced from a support surface on which the walker is placed, and a deployed position in which the foot bar bearing surface moves parallel and adjacent to the support surface on which the walker is placed, each of the first and second pivot connections having a foot bar attachment portion being configured for attachment to respective first and second ends of the foot bar, each of the first and second pivot connections having a walker attachment portion, the walker attachment portion being configured for attachment to opposite lateral sides of the walker, at least one of the pivot connections having a biasing member configured to urge the foot bar in a rotary direction about the foot bar pivot axis.

27. The accessory package of claim 26 wherein the foot bar has first and second arms extending perpendicularly from the respective first and second ends of the foot bar.

28. The accessory package of claim 26 wherein the walker attachment portion of each of the pivot connections is configured to be pivotally connected with a respective lateral opposite side of the frame about an axis perpendicular to the foot bar pivot axis.

29. The accessory package of claim 26 wherein the walker attachment portion of each of the pivot connections is configured to be slidingly connected with a respective lateral opposite side of the frame in a direction perpendicular to the foot bar pivot axis.

30. The accessory package of claim 26 wherein the walker attachment portion of each of the pivot connections has an eyelet portion assembleable with a respective lateral opposite side of the frame, the eyelet portion permitting relative rotary and linear movement between the eyelet portion and the respective lateral opposite of the frame when assembled therewith, and at least one collar for fixing linear movement of the eyelet portion relative to a respective lateral opposite side of the frame and permitting rotary movement between the eyelet portion and the respective lateral opposite of the frame.
